(19) United States
(12) Patent Application Publication
(10) Pub. No.: US 2021/0275967 A1
(43) Pub. Date: Sep. 9, 2021

(54) OSMOTICALLY DRIVEN MEMBRANE PROCESSES AND SYSTEMS AND METHODS FOR DRAW SOLUTE RECOVERY

(71) Applicant: Oasys Water LLC, Dover, DE (US)

(72) Inventor: Zachary W. GOODMAN, Cambridge, MA (US)

(21) Appl. No.: 16/334,529

(22) PCT Filed: Sep. 27, 2017
(86) PCT No.: PCT/US2017/053647

§ 371 Date: Mar. 19, 2019

Related U.S. Application Data
(60) Provisional application No. 62/400,196, filed on Sep. 27, 2016.

(51) Int. Cl. B01D 61/00; B01D 3/14; B01D 53/18

(52) U.S. Cl. CPC B01D 61/005; B01D 3/145; B01D 2311/08; B01D 2311/2626; B01D 2311/2669; B01D 53/18

(57) ABSTRACT

The invention relates to osmotically driven membrane processes and systems and methods for recovering draw solutes in the osmotically driven membrane processes. Osmotically driven membrane processes involve the extraction of a solvent from a first solution by using a second concentrated solution to draw the solvent from the first solution across a semi-permeable membrane. Draw solute recovery may be carried out by various means to recover and recycle draw solutes contained within a diluted second solution and obtain a product solvent.

### CROSS-REFERENCE TO RELATED APPLICATIONS

This application claims priority to and the benefit of U.S. Provisional Patent Application No. 62/400,196, filed Sep. 27, 2016, the entire disclosure of which is hereby incorporated by reference herein in its entirety.

### FIELD OF THE TECHNOLOGY

Generally, the invention relates to osmotically driven membrane processes and more particularly to draw solute recovery techniques for osmotically driven membrane processes.

### BACKGROUND

In general, osmotically driven membrane processes involve two solutions separated by a semi-permeable membrane. One solution may be, for example, seawater, while the other solution is a concentrated solution that generates a concentration gradient between the seawater and the concentrated solution. This gradient draws water from the seawater across the membrane, which selectively permits water to pass, but not salts, into the concentrated solution. Gradually, the water entering the concentrated solution dilutes the solution. The solutes then need to be removed from the dilute solution to generate potable water. Traditionally, the potable water was obtained, for example, via distillation; however, the solutes were typically not recovered and recycled.

In certain prior art systems that use distillation and low grade heat to recover draw solutes, it is necessary to perform condensation and absorption steps under vacuum in an attempt to maximize draw solute recovery. For example, a knock-out pot and an eductor (using air as a driving medium) are disposed downstream of the condensation and/or absorption processes in an attempt to improve draw solute recovery. However, this arrangement requires the venting of the non-condensable gases, which can also result in a loss of draw solutes and possible environmental issues.

### SUMMARY

The invention generally relates to osmotically driven membrane systems and methods, for example, forward osmosis (FO), pressure retarded osmosis (PRO), osmotic dilution (OD), direct osmotic concentration (DOC), and the like, and to systems and methods for draw solute recovery in the osmotically driven membrane systems/processes.

In various embodiments, the separation operation includes using an absorber configured to condense the draw solutes into the concentrated draw solution. The solvent stream, dilute draw solution, or concentrated draw solution may be used as an absorbent in the absorber. Cooling may be used with the absorber. In some embodiments, the process may further include the step of compressing a gas stream resulting from separation of the draw solutes from the dilute draw solution using a gas compressor or a steam eductor driven by hydraulic pressure on an absorbing liquid stream to promote reabsorption of draw solutes into the concentrated draw solution. In various embodiments, the recovery system uses a distillation apparatus (e.g., a packed column or a membrane device) to thermally separate the draw solutes out of a dilute draw solution prior to re-concentrating the separated draw solutes in to the concentrated draw solution.

In one aspect, the invention relates to an apparatus and related method for recovering draw solution solutes from a dilute draw solution. The apparatus includes an osmotically driven membrane system having one or more forward osmosis membranes, wherein the osmotically driven membrane system is configured to introduce a feed solution to a first side of the membranes and a concentrated draw solution to a second side of the membranes and output a concentrated feed solution from the first sides of the membranes and the dilute draw solution from the second sides of the membranes; and a separation system in fluid communication with the osmotically driven membrane system and configured to receive the concentrated feed solution and the dilute draw solution. The separation system includes a first distillation apparatus in fluid communication with the second sides of the membranes and configured for receiving the dilute draw solution and outputting a first vaporized draw solute stream and a product solvent in response to the introduction of a source of thermal energy, a second distillation apparatus in fluid communication with the first sides of the membranes and configured for receiving the concentrated feed solution and outputting a second vaporized draw solute stream and a further concentrated feed solution in response to the introduction of a source of thermal energy, a condenser disposed downstream of and in fluid communication with the first and second distillation apparatus, the condenser configured for receiving the first and second vaporized draw solute streams and a cooling fluid and outputting an at least partially condensed draw solute stream comprising condensed and vaporized draw solutes, and a closed absorption system disposed downstream of and in fluid communication with the condenser and configured for receiving the vaporized portion of draw solutes and the condensed portion of draw solutes and outputting a re-concentrated draw solution stream for return to the osmotically driven membrane system, wherein the closed absorption system comprises an absorber comprising a column and a sump, and a recirculation loop comprising a fluid transfer device (e.g., a pump) and a heat exchanger.

In various embodiments, the first and second sources of thermal energy can be the same source of energy and passed through the first and second distillation apparatus in series or parallel. In some cases the second vaporized draw solute stream can be directed to the first distillation apparatus where it combines with the first vaporized draw solute stream prior to being directed to the condenser.

These and other objects, along with advantages and features of the present invention herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention and are not intended as a definition of the limits of the invention. For purposes of clarity, not every component may be labeled in every drawing. In the following description, various embodiments of the present invention are described with reference to the following drawings, in which:

FIG. 1 is a schematic representation of an exemplary osmotically driven membrane system/process using a solute recovery system in accordance with one or more embodiments of the invention;

FIG. 2 is a simplified schematic representation of an osmotically driven membrane system/process including an alternative draw solute recovery system/process in accordance with one or ore embodiment; the invention;

FIG. 3 is a simplified schematic representation of an osmotically driven membrane system/process including an alternative draw solute recovery system/process in accordance with one or more embodiments of the invention; and

FIG. 4 is a simplified schematic representation of an osmotically driven membrane system/process including an alternative draw solute recovery system/process in accordance with one or more embodiments of the invention.

### DETAILED DESCRIPTION

Various embodiments of the invention may be used in any osmotically driven membrane process, such as FO, PRO, OD, DOC, etc. An osmotically driven membrane process for extracting a solvent from solution may generally involve exposing the solution to a first surface of a forward osmosis membrane. In some embodiments, the first solution (known as a process or feed solution) may be seawater, brackish water, wastewater, contaminated water, a process stream, or other aqueous solution. In at least one embodiment, the solvent is water; however, other embodiments may use non-aqueous solvents. A second solution (known as a draw solution) with an increased concentration of solute(s) relative to that of the first solution may be exposed to a second, opposed surface of the forward osmosis membrane. Solvent, for example water, may then be drawn from the first solution through the forward osmosis membrane and into the second solution generating a solvent-enriched solution via forward osmosis.

Forward osmosis generally utilizes fluid transfer properties involving movement of solvent from a less concentrated solution to a more concentrated solution. Osmotic pressure generally promotes transport of solvent across a forward osmosis membrane from feed to draw solutions. The solvent-enriched solution, also referred to as a dilute draw solution, may be collected at a first outlet and undergo a further separation process. In some non-limiting embodiments, purified water may be produced as a product from the solvent-enriched solution. A second product stream, i.e., a depleted or concentrated process solution, may be collected at a second outlet for discharge or further treatment. The concentrated process solution may contain one or more target compounds which it may be desirable to concentrate or otherwise isolate for downstream use.

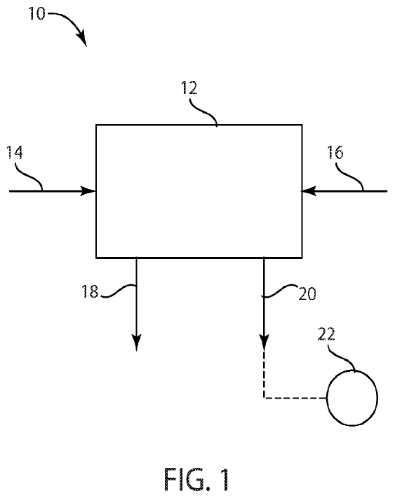

FIG. 1 depicts one exemplary osmotically driven membrane system/process 10 utilizing a draw solute recovery system 22 in accordance with one or more embodiments of the invention. As shown in FIG. 1, the system/process 10 includes a forward osmosis module 12, such as those described in U.S. Pat. Nos. 6,391,205 and 7,560,029; 9,039,899; 9,248,405; 9,266,065; and 9,352,281; and U.S. Patent Publication No. 2014/0224716; the disclosures of which are hereby incorporated by reference herein in their entireties. The module 12 is in fluid communication with a feed solution source or stream 14 and a draw solution source or stream 16. The draw solution source 16 can include, for example, a saline stream, such as sea water, or another solution as described herein that can act as an osmotic agent to dewater the feed source 14 by osmosis through a forward osmosis membrane within the module 12. Examples of draw solutions and draw solute recovery schemes are described in U.S. Patent Publication No. 2015/0273396, the disclosure of which is hereby incorporated by reference herein in its entirety. The module 12 outputs a stream of concentrated solution 18 from the feed stream 14 that can be further processed. The module 12 also outputs a dilute draw solution 20 that can be further processed via the recovery system 22, examples of which are described and/or incorporated herein, where draw solutes and a target solvent can be recovered. In accordance with one or more embodiments of the invention, the draw solutes are recovered for reuse.

In accordance with one or more embodiments, a portion of the dilute draw solution may be used to absorb draw solute gases from, for example, a distillation column. In at least one embodiment, both cooling and mixing with an absorbent may occur in an absorption column or membrane module. The mixing of the gases with a portion of the dilute draw solution acting as an absorbent (to then become the concentrated draw solution) may occur in a vessel. The vessel may generally be sized to provide an area large enough to facilitate interaction between the absorbent and the gases. In some embodiments, a packed column may be used as an absorber. In one or more embodiments, a stripping distillation column and an absorbing column may be used in conjunction. Heating may occur in the distillation column, while cooling and contact with the dilute draw solution absorbent may occur in the absorbing column. In one embodiment, approximately 25% of the dilute draw solution stream may be directed to an absorber to serve as an absorbent fluid, with the remaining approximately 75% of the dilute stream being directed to the stripper as its feed stream. The balance between these two streams will dictate the concentration of the draw solution returned to the membrane system 12, as well as the size of the absorber and/or stripper, and the quantity of heating required in the stripper and cooling required before, after, and/or within the absorber or stages of the absorber.

Additionally, the first solution may be any solution containing solvent and one or more solutes for which separation, purification or other treatment is desired. A process stream to be treated may include salts and other ionic species such as chloride, sulfate, bromide, silicate, iodide, phosphate, sodium, magnesium, calcium, potassium, nitrate, arsenic, lithium, boron, strontium, molybdenum, manganese, aluminum, cadmium, chromium, cobalt, copper, iron, lead, nickel, selenium, silver, and zinc. Such streams may be from an industrial process such as a pharmaceutical or food grade application. Target species may include pharmaceuticals, salts, enzymes, proteins, catalysts, microorganisms, organic compounds, inorganic compounds, chemical precursors, chemical products, colloids, food products, or contaminants. The first solution may be delivered to a forward osmosis membrane treatment system from an upstream unit operation such as industrial facility, or any other source such as the ocean.

Like the first solution, the second solution may be an aqueous solution, i.e., the solvent is water. In other embodiments, non-aqueous solutions such as organic solvents may be used for the second solution. The second solution may be a draw solution containing a higher concentration of solute relative to the first solution. The draw solution may generally be capable of generating osmotic pressure within an osmotically driven membrane system. The osmotic pressure may be used for a variety of purposes, including desalination, water treatment, solute concentration, power generation, and other applications. A wide variety of draw solutions may be used. In some embodiments, the draw solution may include one or more removable solutes. In at least some embodiments, thermally removable (thermolytic) solutes may be used. For example, the draw solution may comprise a thermolytic salt solution. In some embodiments, an ammonia and carbon dioxide draw solution may be used, such as those disclosed in U.S. Pat. No. 7,560,029; however, electrolytic draw solutions are also contemplated and considered within the scope of the invention. Generally, the draw solution should create osmotic pressure and be removable, such as for regeneration and recycling. In some embodiments, the draw solution may be characterized by an ability to undergo a catalyzed phase change in which a draw solute is changed to a gas or solid that can be precipitated from an aqueous solution using a catalyst. In some embodiments, the mechanism may be coupled with some other means, such as heating, cooling, addition of a reactant, or introduction of an electrical or magnetic field.

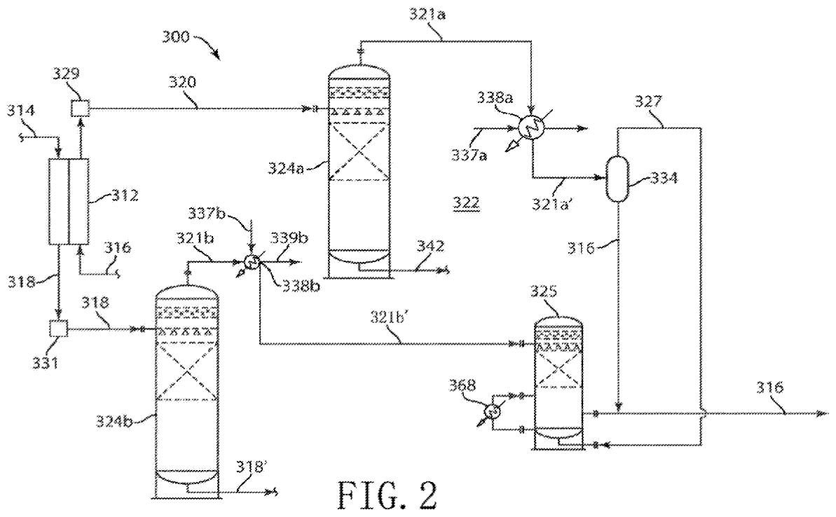

FIG. 2 is a simplified schematic of an osmotically driven membrane system/process 300 similar to those previously described, but with an alternative system/process 322 for recovering draw solutes. Generally, the system 300 includes one or more FO modules 312 in fluid communication with one or more draw solute recovery/separation subsystems 322. The subsystem 322 depicted includes at least two distillation apparatus 324a, 324b, such as distillation columns or membrane distillation apparatus, in fluid communication with a separate absorber apparatus 325, such as a packed column. The system 300 also includes a liquid-vapor separator 334 in fluid communication with at least one of the distillation apparatus 324a and the absorber 325. The system 300 also includes any necessary condensers, pumps, valves, plumbing, etc., along with the other system features (e.g., reboilers, compressors, eductors, etc.) as described or incorporated elsewhere herein. The system 300 also operates similar to those described or incorporated above; however, with a slightly different arrangement of the components and corresponding change in operation.

As shown in FIG. 2, a feed stream 314 and a concentrated draw solution 316 are introduced to the FO membrane module(s) 312, which in turn outputs a concentrated feed stream 318 and a dilute draw solution 320. The concentrated feed stream 318 is directed to the second distillation apparatus 324b, either directly or via a holding tank 331. The concentrated feed 318 is heated (e.g., through the introduction of thermal energy, such as steam or low grade heat, via a reboiler) and the draw solutes that reverse fluxed through the membrane are vaporized (typically along with a small amount of solvent, such as water) and exit the apparatus 324b. The vaporized solutes and solvent mixture 321b is directed to a condenser 338b, which can use an independent source of a cooling fluid 337b (e.g., plant water or other cooling medium, such as an existing fluid stream within the system 300, for example, a portion of the concentrated feed stream 318) introduced to the condenser 338b with a heated fluid 339b exiting the condenser 338b, which can be recycled within the system 300 (e.g., used to preheat the feed 314 or the dilute draw solution 320 prior to introduction to the distillation apparatus 324a. In most, but not all embodiments, the condensed draw solute/solvent mixture 321b′ will be a nitrogen rich liquid. The condensed mixture is directed to the absorber 325 to be used as an absorbent therein. A further concentrated feed stream 318′ is discharged from the second distillation apparatus 324b and can be used as is, discarded or sent for further processing (e.g., to a crystallizer).

Similarly, the dilute draw solution 320 is directed to the first distillation apparatus 324a, either directly or via a holding tank 329. The first and second distillation apparatus 324 can be provided with thermal energy via any of the schemes described or incorporated herein. The dilute draw solution 320 is heated, vaporizing the draw solutes out of the solution along with a small amount of solvent (e.g., water). The draw solutes and solvent mixture 321a exits the distillation apparatus 324a and is directed to a condenser 338a, which can also use an independent source of cooling fluid 337a or another fluid stream within the system 300. The condensed mixture 321a′, which includes liquid and vapor portions of the draw solution, is directed to the liquid-vapor separator 334, where the liquid portion can be removed as concentrated draw solution 316 and the remaining vaporized draw solutes 327 can be directed to the absorber 325. Generally, the separator 334 can be any conventionally known device for liquid-vapor separation, such as a knock-out pot or other gravity-based device; however, it could also be as simple as a vent line in the plumbing to bleed off at least a portion of the gaseous portion of the mixture 321a′. This gaseous portion is typically a carbon rich vapor. The first distillation apparatus 324a also discharges the recovered solvent (e.g., water) 342 that can be used as is or sent for further processing.

Generally, the absorber 325 receives the typically nitrogen rich solution 321b′ (this solution will typically be nitrogen rich if using an NH₃-CO₂ based draw solution, but will vary depending on the type of draw solution used, for example, a two-part draw solution where one element is more likely to diffuse across the membrane and be recovered via apparatus 324b) near the top of the absorber 325, while receiving the carbon rich vapor 327 (this will typically be carbon rich if using the NH₃-CO₂ based draw solution, but will also vary depending on the type of draw solution used) is introduced to the bottom of the absorber 325. Generally, the nitrogen rich solution 321b will absorb the carbon rich vapor, thereby reforming concentrated draw solution 316. The absorber 325 outputs the concentrated draw solution stream 316, which can be combined with the concentrated draw solution 316 exiting the liquid-vapor separator 334. The concentrated draw solution 316 is directed back to the FO membrane module(s) 312, either directly or via a holding tank or additional process (e.g., chemical addition or additional cooling). The absorber 325 receives a source of cooling fluid, similar to those previously disclosed, via its heat exchanger 368. Typically, the reformed concentrated draw solution collects in the bottom of the absorber 325 and can be circulated through the heat exchanger 368 to be cooled before exiting the absorber 325 and being returned to the FO module 312. This arrangement is generally desirable due to the exothermic nature of the process. Again, a portion of the concentrated feed stream 318 can be used for cooling, which also acts to preheat the concentrated feed stream (e.g., prior to introduction to the second distillation apparatus), thereby lessening the thermal requirements for additional concentration thereof and removal of the draw solutes.

Generally, sufficient mixing of the carbon rich vapor 327 and the nitrogen rich solution 321b will occur within the absorber 325; however, in some embodiments, the resulting mixture (i.e., at least partially re-concentrated draw solution 316) may be directed to an external mixing device (e.g., a static mixer) to ensure that the vapors 327 are well mixed within the solution 316 prior to being sent back to the forward osmosis module(s) 312. For example, in some embodiments, the mixture may be condensed within the distillation apparatus 324a reboiler to capture additional waste heat and further cool the re-concentrated draw solution 316.

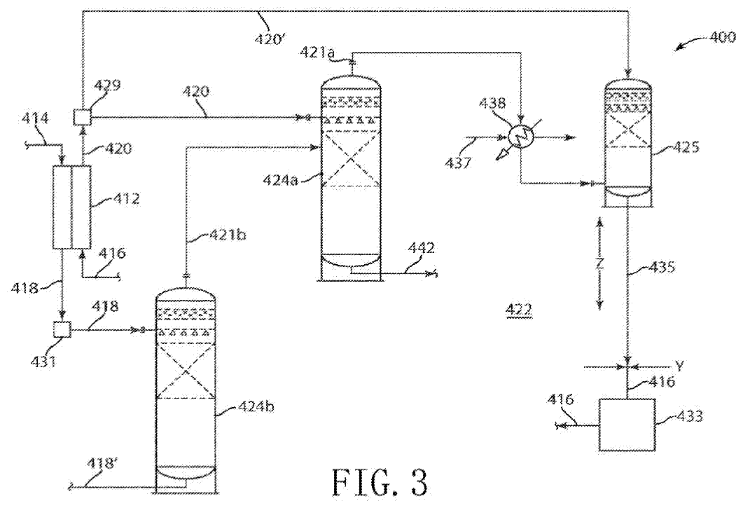

FIG. 3 is a simplified schematic of an osmotically driven membrane system/process 400 similar to those previously described, but with an alternative system/process 422 for recovering draw solutes. Generally, the system 400 includes one or more FO modules 412 in fluid communication with one or more draw solute recovery/separation subsystems 422. The subsystem 422 depicted includes at least two distillation apparatus 424a, 424b, such as distillation columns or membrane distillation apparatus, in fluid communication with a separate condenser/absorber apparatus 425, as described in greater detail below. The system 400 also includes any necessary condensers, pumps, valves, plumbing, etc., along with the other system features (e.g., reboilers, compressors, eductors, etc.) as described elsewhere herein. The system 400 also operates similar to those described above; however, with a slightly different arrangement of the components and corresponding change in operation.

As shown in FIG. 3, a feed stream 414 and a concentrated draw solution 416 are introduced to the FO membrane module(s) 412, which in turn outputs a concentrated feed stream 418 and a dilute draw solution 420. The concentrated feed stream 418 is directed to the second distillation apparatus 424b, either directly or via a holding tank 431. The concentrated feed 418 is heated and the draw solutes that reverse fluxed through the membrane are vaporized (typically along with a small amount of solvent, such as water) and exit the apparatus 424b. The vaporized solutes and solvent mixture 421b is introduced (either directly or via, for example, a compressor) to the first distillation apparatus 424a, as opposed to a condenser as shown in FIG. 2. Similarly, the dilute draw solution 420 is also directed to the first distillation apparatus 424a, either directly or via a holding tank 429 and combined with the mixture 421b from the second distillation apparatus 424b. The first and second distillation apparatus 424 can be provided with thermal energy via any of the schemes disclosed herein. The dilute draw solution 420 is heated vaporizing the draw solutes out of the solution along with a small amount of solvent (e.g., water). The draw solutes and solvent mixture 421a exits the distillation apparatus 424a and is directed to the condenser/absorber apparatus 425 (e.g., a condensation drum). In some embodiments, an optional condenser 438 is provided before the condenser/absorber apparatus 425 to assist in the condensation of the concentrated draw solution vapors 421a. The optional condenser 438 can use an independent source of cooling water 437 or another fluid stream within the system 400 for cooling. Typically, the bottoms product of the first distillation apparatus 424a is a product solvent 442 (e.g., water) that can be used as is or subjected to further processing, and the bottoms product of the second distillation apparatus 424b is a further concentrated feed 418′ (e.g., brine) that can be discarded or sent for further concentration (e.g., via a crystallizer).

The system 400 uses a condensation drum (condenser/absorber apparatus 425) to aid in the condensation of the concentrated draw solution vapors 421a and allow the distillation apparatus 424 to operate under vacuum, which will vastly decrease the energy required to separate the draw solutes from the dilute draw solution 420 and the concentrated feed 418. Generally, the first and second distillation apparatus 424 are located at substantially the same level (e.g., ground level), with the condenser/absorber apparatus 425 located at a higher level (e.g., at or substantially above the height of the distillation apparatus), which enables the vacuum to be generated as described below. Generally, the height of the drum 425 will be dictated by the required level of vacuum for the particular application and may range from about 20 feet to about 80 feet.

During operation, the concentrated draw solution vapors 421a, separated from the product solvent 442 in the first distillation apparatus 424a, are directed into the bottom or proximate the bottom of the drum 425, which is partially filled with dilute draw solution 420 via, for example, a by-pass (stream 420′) from the FO membrane module(s) 412 or holding tank 429 as previously described herein. In one or more embodiments, a portion of dilute draw solution 420′ is also sprayed in at or proximate the top of the drum 425 as a secondary condensing process. In some embodiments, the drum 425 includes a condensing aid, such as a packing material, in order to enhance interfacial contact and increase mixing.

The condensation drum 425 also includes a down pipe 435 with a diameter “y” to facilitate gravity draining of the condensed concentrated draw solution 416 at a sufficient rate and will generally be based on the volume of condensed draw solution exiting the drum 425. The down pipe 435 will have a length “z” (e.g., about 20 feet to about 80 feet), such that a vacuum will be drawn on the distillation apparatus 424 via the apparatus 425. The condensed concentrated draw solution 416 will be drained into a holding tank 433 from where it can be held before returning to the FO membrane module(s) 412. In some embodiments, the tank 433 will include conservation vents to prevent pressure build-up within the tank 433. Additionally, the recovered draw solution 416 can also be subjected to further processing (e.g., additional cooling or other temperature conditioning) prior to being returned to the FO membrane module(s) 412.

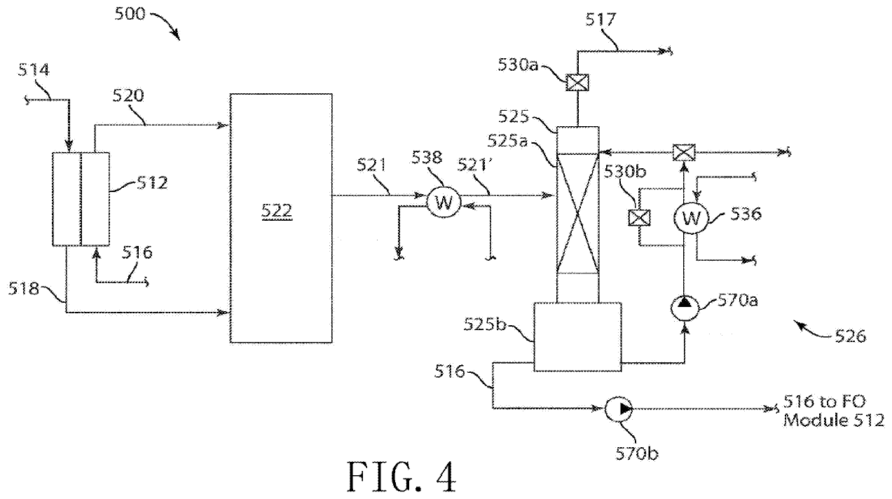

FIG. 4 generally depicts another alternative draw solute recovery scheme that that incorporates an absorber after a condenser. As shown in FIG. 4, and similar to the systems previously described, the system 500 includes one or more forward osmosis modules 512 configured for receiving a feed stream 514 and a concentrated draw solution 516 and outputting a concentrated feed (e.g., brine) 518 and a dilute draw solution 520. One or both of the concentrated feed and dilute draw solution streams can be directed to a separation system 522 as previously described. As part of, or in addition to, the separation system, the system 500 includes the aforementioned condenser 538 generally configured for receiving a vaporized draw solute stream 521 and outputting an at least partially condensed concentrated draw solution stream 521′ (i.e., a two-phase mixture of draw solutes and solvent) to an absorption system(s) 526 including an absorber 525 and a recirculation loop. In some embodiments, the condenser 538 may receive a mixture of vaporized and partially condensed draw solutes; for example, where multiple condensers are used. As previously discussed, the absorber 525 is generally sized based on the bubble rise rate of the vaporized draw solutes entering the absorber in order to provide sufficient residence time to as fully as possible absorb the vaporized draw solutes into the concentrated/condensed draw solution 516. The overall flow rates and volumes of the various draw solution based streams will vary to suit a particular application and also dictate the size and orientation of the absorber 525. However, the absorption system 526 is configured and operated contrary to conventional absorbers and absorption processes, at least in part, because it is a closed system (e.g., no carrier gas or other flow stream is vented from the absorber 525) and it also incorporates a recirculation and cooling loop as described in greater detail below.

More specifically, as shown in FIG. 4, the absorber system 526 includes the absorber 525 having an absorption column 525a at least partially filled with a packing material and a sump 525b disposed below and in fluid communication with the absorption column 525a; a recirculation pump 570a, and a heat exchanger 536, along with any necessary valves, sensors, controls, and plumbing. The absorption system 526 may also include a pressure actuated valve 530a as a safety device in the event of an over-pressurization event or a shut-off valve for, for example, bleeding any initial vapors 517 during start-up. The absorption system 526 may also include a transfer pump 570b in fluid communication with the sump 525b to remove any concentrated draw solution 516 that has collected therein. Generally, the recirculation loop allows for controlling the pressure profile and temperature within the column 525a to provide for enhanced draw solute recovery. For example, the recirculation provides increased flow through the packing within the column 525a, significantly increasing the overall surface area for gas/liquid contact and dwell time, while the cooling removes the heat generated by the absorption process and allows the system to run at a steady state. This contact area is where the reaction between the draw solutes (e.g., ammonium and CO₂) takes place, pulling the gaseous solute (e.g., CO₂) into solution. The greater the area, the greater the absorption. Since there is no gas outlet, all of the gas in the column must be consumed.

In various embodiments, the overall height of the absorption column 525a is about 5 feet to about 50 feet, preferably about 10 feet to 30 feet, and more preferably about 15 feet to 25 feet. Generally, the overall height is chosen to provide the optimum dwell time for the gas to achieve substantial absorption and will be selected to suit the particular application, for example, the size can be based on the system feed rate or volume of final condensed draw solution to be obtained. In ne embodiment, the height is about 10 feet. Typically, the packing within the column will run about 20% to 80% of the height of the column 525a, preferably about 30% to 70%, and more preferably about 40% to 60%. Ideally, the overall amount of packing will be minimized for the specific application with enough provided to facilitate substantially complete absorption of the gaseous draw solutes. The diameter of the column 525a will vary to suit a particular flow rate of the draw solution mixture 521′ from the condenser 538. In some embodiments, the diameter of the column 525a is about 6 inches to 36 inches, preferably about 10 inches to 30 inches, and more preferably about 12 inches to 24 inches. For larger applications, e.g., diameters over 30 inches, it is possible to use two or more columns in parallel. In some embodiments, for example where the system is configured for turn-down capability (e.g., operating at 50% capacity vs. 100% capacity), multiple columns can be used (e.g., two columns with each column sized for 50% capacity). The sump 525b will have a volumetric capacity to suit a particular application and will range from about 5 gallons to 500 gallons, preferably about 10 gallons to 100 gallons, and more preferably about 25 gallons to 50 gallons. The recirculation loop will be sized for a flow rate of about 1 gpm to 20 gpm, preferably about 2 gpm to 10 gpm, and more preferably about 3 gpm to 5 gpm. Generally, the recirculation flow rate is relative to the flow rate into the absorber column 525a (521′) from the condenser 538 and/or the flow rate out of the sump 525b (516) and will range from about 0.5 to about 20 times the inlet/outlet flow rates, preferably about 1 to about 10 times the inlet/outlet flow rates, and more preferably about 2 to about 5 times those flow rates. In a particular embodiment, the column has a height of about 100 inches and a diameter of about 6 inches and a sump volume of about 1.5 m³ to suit an application to produce about 100 m³/d of concentrated draw solution. In some embodiments, the recirculation range is about 1 to 10 gpm and is about 2-3× the column feed flow, with a column/sump residence time of about 10-40 minutes, preferably about 20-30 minutes.

As previously mentioned, the absorption system 526 of FIG. 4 is operated contrary to how a conventional absorber column is operated. The disclosed column configuration is fundamentally different in that there is no vapor effluent of condensable gases. The column 525a operates with a closed vapor outlet and the influent draw solute gas(es) is absorbed fully. This difference forces the column 525a to be operated in a non-traditional manner. Traditional packed columns use a lean solvent to strip out a constituent of a vapor stream. Specifically, conventional absorbers operate by directing a carrier gas or other stream through the vessel to absorb or be absorbed by another stream within the absorber, with the carrier gas or other stream traveling directly through or otherwise vented from the absorber. In the disclosed embodiments, there is a very concentrated solvent absorbing a gas until it is nearly saturated. It is, in fact, highly undesirable for there to be any carrier gas, which would contaminate the draw solution being reconstituted and introduce non-condensable gases into the system that would require venting and result in the loss of the desirable draw solution vapors. Since there is no additional gas (e.g., a carrier gas), pressure management in the column is critical, because if the balance is not right then a vacuum can be induced or pressure can build within the column. Additionally, the Applicants found that a recirculation loop in combination with a conventional absorber column was ineffective for enhancing draw solute recovery and the regeneration of concentrated draw solution. A recirculation loop in combination with temperature control and a closed absorber column provided steady run pressure and temperature profiles and makes running the column possible. This unique arrangement of operating a packed column as a total condenser for the make-up and recovery of specialized draw solutions eliminates the need for the carrier gas, contrary to all recommendations from engineering consultants and column manufacturers that the Applicants consulted.

The addition of the recirculation loop does two things: because the recirculation is cooled, it controls the temperature of the column and removes the heat from the exothermic absorption reactions; and because the column is partially flooded during the recirculation process, it creates a favorable pressure profile by causing a substantially static pressure profile where there is a higher pressure at the bottom of the column 525a than at the top. When operating at a steady state, a constant pressure profile indicates that substantially all of the vapors are being absorbed. Without the right recirculation flow, the pressure profile can be non-existent or reversed. Lower pressure at the top ensures that the unabsorbed vapor moves up through the packing. Essentially, the absorption system 526 is a mass transfer device with a high gas-liquid surface area and storage (sump 525b) to provide increased dwell time for the CO₂ to react and be absorbed, which is not possible in conventional absorber columns. The use of the absorption system 526 described herein allows the upstream condenser 538 to be reduced in size (e.g., fewer and/or smaller heat transfer plates) as some of that duty is shifted to the absorption system 526, thereby reducing the capital expense of the overall system 500.

Often, when using a draw solution having two or more solutes of differing solubility, one solute is more readily recovered than the other. For example, when using a NH₃-CO₂ draw solution, not all the CO₂ is absorbed into the solution in the upstream condenser 538. As such, a liquid-gas two phase flow 521′ is introduced to the absorber column 525a, typically just below the packing. In a particular example, the stream 521′ contains NH₃/CO₂/H₂O with a NH₃/CO₂ mole ratio of about 2.0 to 4.0, more preferably about 2.0 to 3.0, and more preferably 2.2-2.3 and the gas contains mainly CO₂ at partial pressure well above equilibrium. The gas will also contain low concentrations of water and NH₃ in equilibrium with the solution. The gas concentration and partial pressure of the species depends on the temperature and the pressure of the solution in the condenser 538.

In operation, once the stream 521′ enters the absorber column 525a, the liquid portion of the stream drops to the sump or storage tank 525b disposed below the column 525a and the gas flows upwards. Using the pump 570a to recycle the liquid through the packing and controlling the temperature of the liquid using the heat exchanger 536 and the bypass 530b around it allows for very robust control of the amount of CO₂ that is captured by the recirculated liquid and thus of the pressure in the absorber column 525a. If the absorber column 525a is designed for atmospheric+pressure and the absorption system 526 absorbs too little of the gas, the pressure in the column 525a will rise. If the situation is not corrected (e.g., by increasing the recirculation flow and/or lowering the temperature of the recirculation flow) the pressure release valve 130a will be tripped and CO₂ will be lost to the atmosphere and need to be replaced. If the absorption system 526 absorbs the gas too quickly, a vacuum may be pulled on the column 525a, potentially tripping the pressure relieve valve 130a (e.g., an additional vacuum break or check valve or via the use of a conservation valve) introducing air (a non-condensable gas) into the system 526, which would negatively impact the draw solute recovery process if not corrected (e.g., by reducing the recirculation flow and/or increasing the temperature of the recirculation flow). Correct sizing of the absorber 525 and proper control of the CO₂ absorption rate by controlling the recirculation flow rate, the concentrated draw solution return flow rate, and the temperature of the recirculation flow provides for enhanced draw solution recovery.

During an exemplary operation with a NH₃-CO₂ draw solution, the partially condensed draw solution vapors 521′ are directed to the absorber system 526 at a temperature of about 20° to 40° C. (e.g., slightly higher in temperature than the cooling fluid used in the condenser 538), where the temperature of the solution increase due to the heat generated by the absorption process, but the solution is cooled via the recirculation heat exchanger back to a temperature of about 20° to 40° C. Generally, the recirculation flow should be cool enough so as to not volatize any of the draw solutes (e.g., CO₂), thereby impeding absorption. The flow rates will vary depending on the size of the overall system 500, with the recirculation flow being adjusted to maintain a steady pressure profile within the column 525a. In some cases, the concentrated draw solution mass flow 516 rate is approximately equal to the mass flow rate of the mixture 521′ entering the absorber column 525a, as the absorber column 525a becomes flooded as the process begins and then an equivalent rate is pulled off of the sump 525b as it is a closed system.

In accordance with one or more embodiments, the devices, systems and methods described herein may generally include a controller for adjusting or regulating at least one operating parameter of a device or a component of the systems, such as, but not limited to, actuating valves and pumps, as well as adjusting a property or characteristic of one or more fluid flow streams through an osmotically driven membrane module, or other module in a particular system. A controller may be in electronic communication with at least one sensor configured to detect at least one operational parameter of the system, such as a concentration, flow rate, pressure, pH level, or temperature. The controller may be generally configured to generate a control signal to adjust one or more operational parameters in response to a signal generated by a sensor. For example, the controller can be configured to receive a representation of a condition, property, or state of any stream, component, or subsystem of the osmotically driven membrane systems and associated recovery systems. The controller typically includes an algorithm that facilitates generation of at least one output signal that is typically based on one or more of any of the representation and a target or desired value such as a set point. In accordance with one or more particular aspects, the controller can be configured to receive a representation of any measured property of any stream, and generate a control, drive or output signal to any of the system components, to reduce any deviation of the measured property from a target value.

In accordance with one or more embodiments, process control systems and methods may monitor various concentration levels, such as may be based on detected parameters including pH and conductivity. Process stream flow rates and tank levels may also be controlled. Temperature and pressure may be monitored, along with other operational parameters and maintenance issues. Various process efficiencies may be monitored, such as by measuring product water flow rate and quality, heat flow and electrical energy consumption. Cleaning protocols for biological fouling mitigation may be controlled such as by measuring flux decline as determined by flow rates of feed and draw solutions at specific points in a membrane system. A sensor on a brine stream may indicate when treatment is needed, such as with distillation, ion exchange, breakpoint chlorination or like protocols. This may be done with pH, ion selective probes, Fourier Transform Infrared Spectrometry (FTIR), or other means of sensing draw solute concentrations. A draw solution condition may be monitored and tracked for makeup addition and/or replacement of solutes Likewise, product water quality may be monitored by conventional means or with a probe such as an ammonium or ammonia probe. FTIR may be implemented to detect species present providing information which may be useful to, for example, ensure proper plant operation, and for identifying behavior such as membrane ion exchange effects.

Having now described some illustrative embodiments of the invention, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives.

Furthermore, those skilled in the art should appreciate that the parameters and configurations described herein are exemplary and that actual parameters and/or configurations will depend on the specific application in which the systems and techniques of the invention are used. Those skilled in the art should also recognize or be able to ascertain, using no more than routine experimentation, equivalents to the specific embodiments of the invention. It is, therefore, to be understood that the embodiments described herein are presented by way of example only and that, within the scope of any appended claims and equivalents thereto; the invention may be practiced otherwise than as specifically described.

What is claimed is:

1. An apparatus for recovering draw solution solutes from a dilute draw solution, the apparatus comprising:
an osmotically driven membrane system comprising one or more forward osmosis membranes, wherein the osmotically driven membrane system is configured to introduce a feed solution to a first side of the membranes and a concentrated draw solution to a second side of the membranes and output a concentrated feed solution from the first sides of the membranes and the dilute draw solution from the second sides of the membranes; and
a separation system in fluid communication with the osmotically driven membrane system and configured to receive the concentrated feed solution and the dilute draw solution, the separation system comprising:
a first distillation apparatus in fluid communication with the second sides of the membranes and configured for receiving the dilute draw solution and outputting a first vaporized draw solute stream and a product solvent in response to the introduction of a source of thermal energy;
a second distillation apparatus in fluid communication with the first sides of the membranes and configured for receiving the concentrated feed solution and outputting a second vaporized draw solute stream and a further concentrated feed solution in response to the introduction of a source of thermal energy;
a condenser disposed downstream of and in fluid communication with the first and second distillation apparatus, the condenser configured for receiving the first and second vaporized draw solute streams and a cooling fluid and outputting an at least partially condensed draw solute stream comprising condensed and vaporized draw solutes;
a closed absorption system disposed downstream of and in fluid communication with the condenser and configured for receiving the vaporized portion of draw solutes and the condensed portion of draw solutes and outputting a re-concentrated draw solution stream for return to the osmotically driven membrane system, wherein the closed absorption system comprises an absorber comprising a column and a sump, and a recirculation loop comprising a fluid transfer device and a heat exchanger.
